(19) United States
(12) Patent Application Publication
(10) Pub. No.: US 2006/0283009 A1
(43) Pub. Date: Dec. 21, 2006

(54) Component mounting apparatus including a demagnetizing device and method thereof

(76) Inventors: Dong-Woo Shin, Cheonan-si (KR); Byong-Kun Bae, Cheonan-si (KR); Nam-Yong Oh, Cheonan-si (KR); Dong-Chun Lee, Cheonan-si (KR); Seong-Chan Han, Cheonan-si (KR); Sun-Kyu Hwang, Asan-si (KR)

Correspondence Address: HARNESS, DICKEY & PIERCE, P.L.C., P.O. BOX 8910, RESTON, VA, 20195, US

(21) Appl. No.: 11/452,902

(22) Filed: Jun. 15, 2006

(30) Foreign Application Priority Data
Jun. 16, 2005 (KR) 2005-51976

(51) Int. Cl. B23P 19/00

(52) U.S. Cl. 29/743; 29/740; 29/741; 29/759; 29/833

(57) ABSTRACT

An electronic component mounting apparatus that includes a demagnetizer used to demagnetize a head nozzle, and a method for demagnetizing an electronic component apparatus. The method may include setting conditions, mounting electronic components, and demagnetizing a head nozzle of the electronic component mounting apparatus based on the conditions.

### PRIORITY STATEMENT

This U.S. non-provisional application claims benefit of priority under 35 U.S.C. §119 of Korean Patent Application No. 2005-51976, filed on Jun. 16, 2005, the entire contents of which are incorporated herein by reference.

### BACKGROUND OF THE INVENTION

1. Field of the Invention

Example embodiments of the present invention relates to an electronic component mounting apparatus, and more particularly, to an apparatus and method for demagnetizing an electronic component mounting apparatus.

2. Description of the Related Art

Generally, an electronic component mounting apparatus may mount electronic components, including a passive chip, an integrated circuit package, etc., on a printed circuit board (PCB).

A conventional electronic component mounting apparatus may comprise a component feeder for feeding electronic components and a component mounter for mounting the electronic components on a PCB. The component feeder may have a mount head for picking up the electronic components and/or transferring the electronic components to the component mounter. The mount head may have a head nozzle for absorbing the electronic components using a vacuum. The apparatus may further comprise a device for applying a solder paste to the PCB before mounting the electronic components. The apparatus may further comprise a device for performing a solder reflow process after mounting the electronic components.

A process for mounting electronic components may proceed at a high speed. For example, the mounting of an electronic component on a PCB may require between several tenths and one-hundredth of a second according to the type of mounting apparatus. Recently, electronic component mounting apparatuses have moved towards higher speeds. Several years ago, the number of electronic components mounted per hour was about ten thousand, whereas the number of electronic components mounted per hour is currently about fifty thousand.

Further, the dimensions of electronic components have decreased over time. For example, several years ago the size of a passive chip was about 3.2 by 1.6 mm or about 2.0 by 1.2 mm, whereas the current size is about 1.6 by 0.8 mm, 1.0 by 0.5 mm, 0.6 by 0.3 mm, or 0.4 by 0.2 mm.

Several issues may result from the high speed of electronic component mounting apparatuses and/or the small size of electronic components. For example, one issue is that the magnetization of a head nozzle may result in procedural faults.

For example, a head nozzle may attract electronic components using a vacuum, mount the electronic components on a PCB, and separate from the electronic components by release of the vacuum. The head nozzle may be formed of iron having a long life and excellent manageability characteristics. The head nozzle may be magnetized by friction with electronic components through repetitive operations. If the head nozzle is magnetic, despite a release of the vacuum, the head nozzle may attract electronic components due to magnetism. As a result, the head nozzle may fail to mount the electronic components on a PCB and/or may inadvertently pick up a subsequent electronic component.

As the size of an electronic component reduces, the electronic component becomes more susceptible to magnetism. Further, as an electronic component mounting apparatus operates at a higher speed, a head nozzle becomes more severely magnetized.

If faults occur due to magnetism of a head nozzle, conventionally an operator may manually demagnetize the head nozzle in question. The manual demagnetization by the operator may result in a loss of time, thereby reducing productivity.

### SUMMARY OF THE INVENTION

An example embodiment of the present invention is directed to automatically demagnetizing a head nozzle of an electronic component mounting apparatus.

An example embodiment of the present invention is directed to improving reliability and/or productivity of an electronic component mounting apparatus and method.

An example embodiment of the present invention provides an electronic component mounting apparatus. The electronic component apparatus may comprise a head table, at least one mount head arranged on the head table, a head nozzle provided at a lower end of the mount head, a component feeder configured to provide electronic components, a component sensor configured to sense the electronic components, a component mounter configured to mount the electronic components on a PCB, and a demagnetizer configured to create an alternating magnetic field to demagnetize the head nozzle.

An example embodiment of the present invention provides a method for demagnetizing an electronic component mounting apparatus. The method may comprise setting conditions including at least one of a demagnetizing cycle, nozzle operating conditions and demagnetizing conditions, mounting electronic components, and demagnetizing a head nozzle of the electronic component mounting apparatus based on the set conditions.

An example embodiment of the present invention provides an electronic component mounting apparatus. The electronic component mounting apparatus may include a head nozzle configured to transfer electronic components to a component mounter and a demagnetizer configured to create an alternating magnetic field to demagnetize the head nozzle.

### BRIEF DESCRIPTION OF THE DRAWINGS

The present invention will be readily understood with reference to the following detailed description of example embodiments of the present invention provided in conjunction with the accompanying drawings, wherein like reference numerals designate like structural elements.

FIG. 1 is a schematic diagram of an example embodiment of an electronic component mounting apparatus having a demagnetizer in accordance with an example embodiment of the present invention.

FIG. 2 is a side view of a mount head of the electronic component mounting apparatus in FIG. 1 according to an example embodiment of the present invention.

FIG. 3 is a perspective view of an example demagnetizer of an electronic component mounting apparatus in FIG. 1 according to an example embodiment of the present invention.

FIG. 4 is a schematic diagram of an electronic component mounting apparatus having a demagnetizer in accordance with an example embodiment of the present invention.

FIGS. 5A and 5B are side views of a mount head of the electronic component mounting apparatus in FIG. 4 according to an example embodiment of the present invention.

FIG. 6 is a perspective view of a demagnetizer of the electronic component mounting apparatus in FIG. 4 according to an example embodiment of the present invention.

FIG. 7 is a flow chart of a demagnetizing method in accordance with an example embodiment of the present invention.

These drawings are provided for illustrative purposes only and are not drawn to scale. The spatial relationships and relative size of the elements illustrated in the various embodiments may have been reduced, expanded or rearranged to improve the clarity of the figure with respect to the corresponding description. The figures, therefore, should not be interpreted as accurately reflecting the relative sizing and/or positioning of the corresponding structural elements that could be encompassed by an actual device manufactured according to the example embodiments of the present invention.

### DETAILED DESCRIPTION OF THE EXAMPLE EMBODIMENTS

Example, non-limiting embodiments of the present invention will now be described more fully hereinafter with reference to the accompanying drawings. This invention may, however, be embodied in many different forms and should not be construed as limited to the example embodiments set forth herein. Rather, the disclosed example embodiments of the present invention are provided so that this disclosure will be thorough and complete, and will fully convey the scope and teachings of the example embodiments of the present invention to those skilled in the art. The principles and features of the example embodiments of the present invention may be employed in varied and numerous embodiments without departing from the scope of the invention.

It should be noted that the figures are intended to illustrate the general characteristics of methods and devices of example embodiments of the present invention for the purpose of describing the example embodiments of the present invention herein. These figures may not be to scale and may not precisely reflect the characteristics of any given embodiment, and should not be interpreted as defining or limiting the range of values and/or properties of example embodiments of the present invention. Rather, for simplicity and clarity of illustration, the dimensions of some of the elements of example embodiments of the present invention may be exaggerated relative to other elements of example embodiments of the present invention. Like reference numerals are used for like and/or corresponding parts throughout the figures.

Further, well-known structures and processes are not described and/or illustrated in detail to avoid obscuring the teachings of the example embodiments of the present invention.

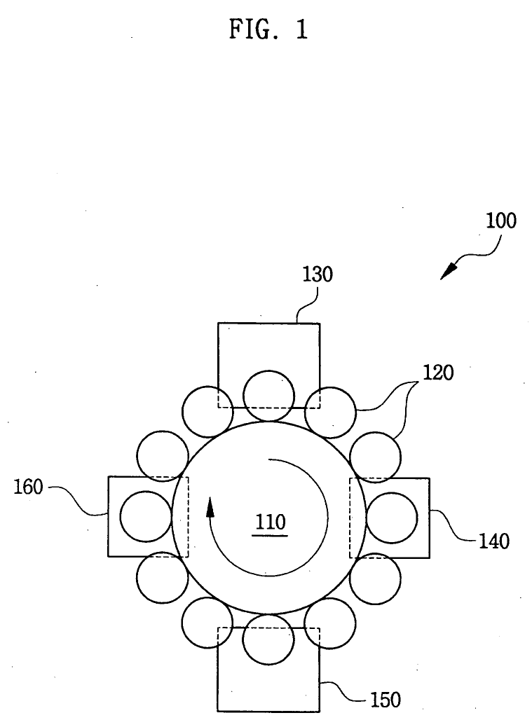

FIG. 1 is a schematic diagram of an example embodiment of an electronic component mounting apparatus 100 according to the present invention. The electronic mounting apparatus may include a demagnetizer 160 according to an example embodiment of the present invention.

According to an example embodiment of the present invention as illustrated in FIG. 1, the electronic component mounting apparatus 100 may include a head table 110, at least one mount head 120, a component feeder 130, a component sensor 140, a component mounter 150, and a demagnetizer 160. The component feeder 130, the component sensor 140, the component mounter 150, and the demagnetizer 160 may be arranged around head table 110 (e.g., at the four quarters of the head table 110 as shown in FIG. 1).

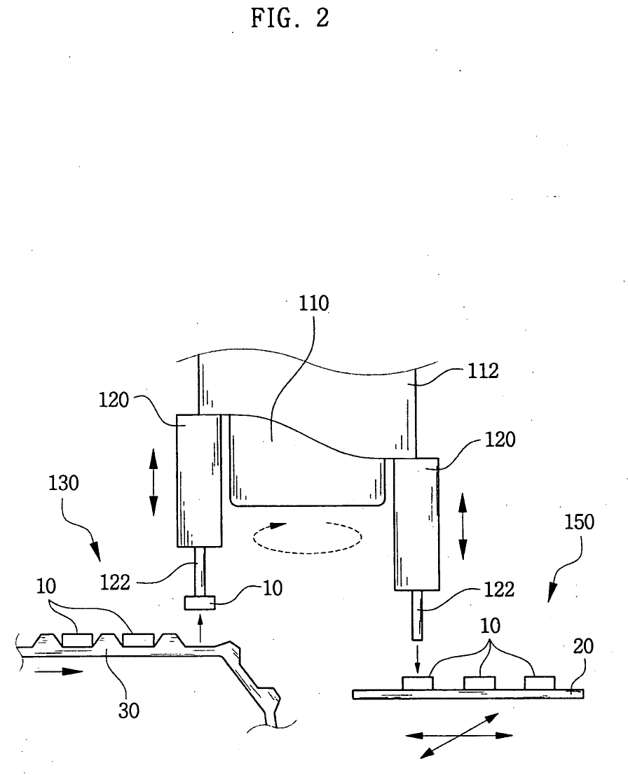

According to an example embodiment of the present invention, the head table 110 may be cylindrical and may be configured to rotate. The mount heads 120 may be provided around the periphery of the head table 110. The number of the mount heads 120 may vary. For example the number of mount heads 120 may be 3, 12, 16, 35, etc. Further, an example embodiment of the present invention may include a cam follower 112 that may be connected to a head table 110. For example, as illustrated in FIG. 2, a cam follower 112 may be installed at the top of the head table 110 and may be configured to move the mount head 120 and/or one or more head nozzles 122 attached thereto vertically. For example, one or more head nozzles 122 may be installed at the bottom of the mount head 120 and may be configured to move electronic components 10. A rotor (not shown) may also be installed at the bottom of the mount head 120 for implementing head nozzles 122 of different shapes and/or sizes. The size, shape, etc. of the head nozzles 122 may vary based on various characteristics (e.g., size, shape, etc.) of the electronic components 10 being transferred and/or mounted using the head nozzles 122.

According to an example embodiment of the present invention as illustrated in FIG. 2, the component feeder 130 may feed the electronic components 10 to the head nozzles 122. The electronic components 10 may include passive devices such as a capacitor, resistors, integrated circuit packages, etc. The electronic components 10 may pass through a manufacturing process and be provided in a container 30 of a reel type to a component feeder 130. A head nozzle 122, which may be attached to a mount head 120, may attract the electronic component 10 from the component feeder 130.

According to an example embodiment of the present invention, the head table 110 may rotate to locate the head nozzle 122 above the component sensor 140. The component sensor 140 may sense the positional precision of the electronic component 10 on the head nozzle 122.

According to an example embodiment of the present invention, the head table 110 may rotate to locate the head nozzle 122 above the component mounter 150. The head nozzle 122 may release the vacuum to place the electronic component 10 on a printed circuit board (PCB) 20. A solder paste may be applied on the PCB 20 before and/or after an electronic component 10 is placed on a PCB 20. The electronic component 10 may be attached to the solder paste. A component mounter 150 according to an example embodiment of the present invention may include an X-Y table (not shown), which may be configured to adjust the mounting position of the electronic component 10. For example, an X-Y table may be configured to move horizontally.

According to an example embodiment of the present invention, the head table 110 may rotate such that a mount head 120 and corresponding head nozzle 122, which may have placed an electronic component 10 on a PCB 20, move from a position above a component mounter 150 towards a position above the component feeder 130, wherein the head nozzle 122 may absorb a second electronic component 10. In accordance with the electronic component mounting apparatus 100 of an example embodiment of the present invention, a plurality of the head nozzles 122 may substantially continuously mount electronic components 10 with a rotating head table 110.

According to an example embodiment of the present invention, a demagnetizer 160 may be provided in the rotating route of a mount head 120. The rotating route may be the route and/or path that one or more of the head nozzles 122 and/or mount heads 120 attached to the rotating head table 110 follows during operation of the electronic mounting apparatus 100. For example, as illustrated in FIG. 1, the demagnetizer 160 may be located in a position in the rotating route such that a mount head 120 rotates to a position corresponding to the demagnetizer 160 after the mount head 120 has left a position corresponding to the component mounter 150 and before the mount head 120 reaches the position of the component feeder 130.

According to an example embodiment of the present invention a controller (not shown) may be configured to control the operations of the electronic mounting apparatus 100. For example, a controller may control the rotating of the head table 110, movement of the head nozzles 122, movement of the cam follower 112, etc. Further, for example, a controller (not shown) may be configured to control the specifics of the rotating route described above.

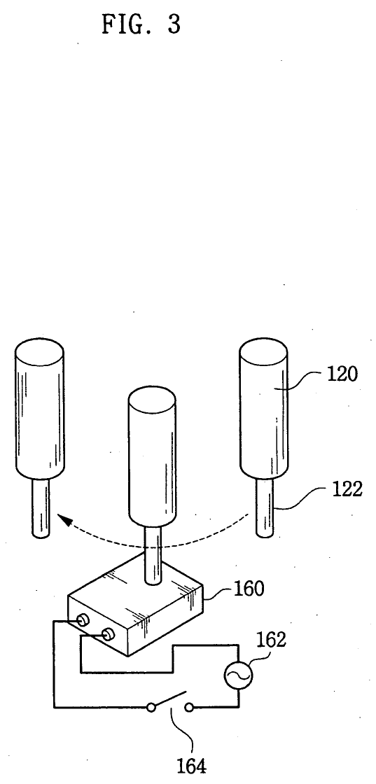

FIG. 3 is a perspective view of an example embodiment of a demagnetizer of an electronic component mounting apparatus 100 according to the present invention. A demagnetizer 160 may have a frame and an iron core having coils embedded in the frame. The frame may be rectangular for example. An example embodiment of a demagnetizer 160 may create a magnetic field when current flows through the coils. For example, a demagnetizer 160 may be connected to an alternating power supply 162 through a switch 164. When the switch 164 is closed, the demagnetizer 160 may create an alternating magnetic field by the current flowing through the coils.

According to an example embodiment of the present invention, the head nozzle 122 of the mount head 120 may be moved into a location within an alternating magnetic field generated by a demagnetizer during each cycle of rotation, thereby removing magnetism from the head nozzle 122. For example, the head table 110 may rotate to repetitively move each head nozzle 122 above the demagnetizer 160 at least once during a rotating cycle to demagnetize the head nozzle 122.

A demagnetizer 160 according to an example embodiment of the present invention may have a variety of capacities, for example 0.46 KVA, 0.5 KVA, 1 KVA, 1.5 KVA, 1.6 KVA, 3 KVA, 5 KVA, 6 KVA, and 11 KVA. Further, the demagnetizer 160 may be selected according to the characteristics and/or size of the electronic components 10, as well as the standard and/or processing speed of the head nozzle 122 (e.g., the number of components mounted per hour).

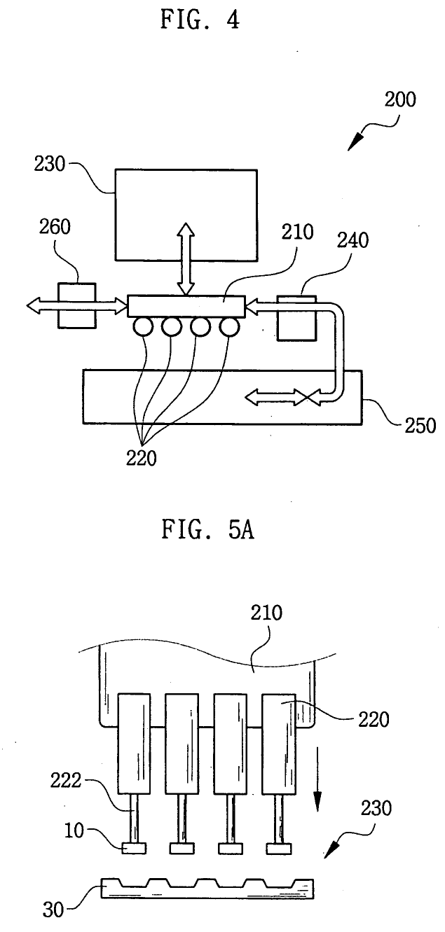

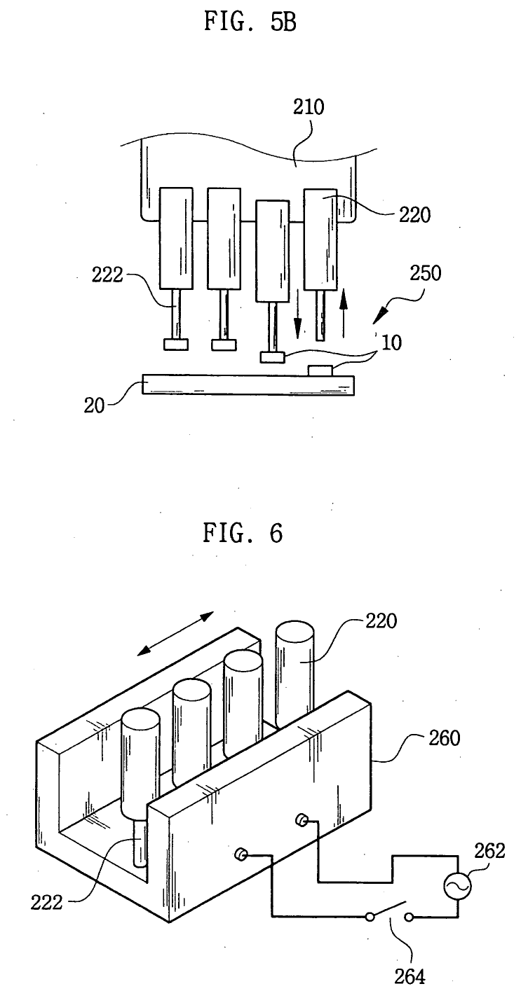

FIG. 4 is a schematic diagram of an example embodiment of an electronic component mounting apparatus 200 having a demagnetizer 260 according to an example embodiment of the present invention. FIGS. 5A and 5B are side views of a mount head 220 of the example embodiment of electronic component mounting apparatus 200 shown in FIG. 4. As illustrated in FIG. 4, an example embodiment of the electronic component mounting apparatus 200 according to the present invention may mount electronic components 10 using a horizontal movement of a head table 210.

Referring to FIG. 4, an example embodiment of an electronic component mounting apparatus 200 according to the present invention may comprise a head table 210, at least one mount head 220, a component feeder 230, a component sensor 240, a component mounter 250, and a demagnetizer 260. For example, a component feeder 230, component sensor 240, component mounter 250, and demagnetizer 260 may be arranged proximal to a head table 210.

According to an example embodiment of the present invention, the head table 210 may have a driver (not shown) for horizontally moving the head table 210. The mount heads 220 may be arranged along one side of the head table 210. The number of the mount heads 220 may vary. For example, the number of the mount heads may be 2, 3, 4, 8, 23, etc. A plurality of hydraulic cylinders (not shown) may be installed at the top of the head table 210 and may be configured to move the mount head 220 vertically. A head nozzle 222 may be installed at the bottom of one or more mount heads 220 and may be configured to transfer electronic components 10. As shown in FIG. 4, a head table 210 according to an example embodiment of the present invention may be configured to move horizontally.

As illustrated in an example embodiment of the present invention shown in FIG. 5A, electronic components 10 may be provided in a container 30 (e.g., a reel type) to the component feeder 230. A head table 210 may move to the component feeder 230 and a head nozzle 222 of the mount head 220 may absorb the electronic component 10 using vacuum. Further, the mount heads 220 may simultaneously move downwards and upwards when the head nozzles 222 absorb the electronic components 10. With the head nozzle 222 absorbing the electronic component 10, the head table 210 may move to a position above the component sensor 240. The component sensor 240 may sense a variety of characteristics including location information, electronic component information, positional precision of the electronic component 10 on the head nozzle 222, etc. The component sensor 240 may use a scanning method.

Referring to FIG. 5B, according to an example embodiment of the present invention, the head table 210 may move to a mounting position above the component mounter 250. The mount heads 220 may move downwards one-by-one, and the head nozzles 222 may place the electronic components 10 on a PCB 20. The one-by-one mounting may be varied to provide differences in the distance between adjacent mount heads 220 and the distance between adjacent electronic components 10. The operation of the mount heads 220 may be staggered with the horizontal movement of a head table 210, thereby adjusting the mounting positions of the electronic components 10. For example, if the distance between the mount heads 220 is equal to a desired distance between the electronic components 10, the mount heads 220 may simultaneously operate.

According to an example embodiment of the present invention, an X-Y table (not shown) may move instead of the head table 210 to adjust the mounting position of the electronic components 10.

According to an example embodiment of the present invention, the head table 210 may move to a component feeder 230 to allow the head nozzles 222 to absorb electronic components 10.

According to an example embodiment of the present invention, a demagnetizer 260 may be located at any location within a moving route and/or path of a head table 210. The moving route and/or path may be the route in which the head table 210 follows during operation of an electronic mounting apparatus 200. For example, the moving route and/or path may include one or more routes and/or paths, which connect the demagnetizer 260 to one or more other components of the electronic mounting apparatus 200 (e.g., the component feeder 230, component mounter 250, etc.).

According to an example embodiment of the present invention a controller (not shown) may be configured to control the operations of the electronic mounting apparatus 200. For example, a controller (not shown) may control the movement of the head table 210 and may instruct the head table 210 to follow a specified moving route.

FIG. 6 is a perspective view of a demagnetizer 260 according to an example embodiment of the present invention.

Referring to FIG. 6, the demagnetizer 260 may have a U-shaped frame and an iron core having coils embedded in the U-shaped frame. The demagnetizer 260 may be connected to an alternating power supply 262 through a switch 264. The head table 210 may operate to move the head nozzle 222 into the magnetic field created by the demagnetizer 260, thereby demagnetizing the head nozzle 222. The demagnetizer 260 may be formed of a table or of a tunnel.

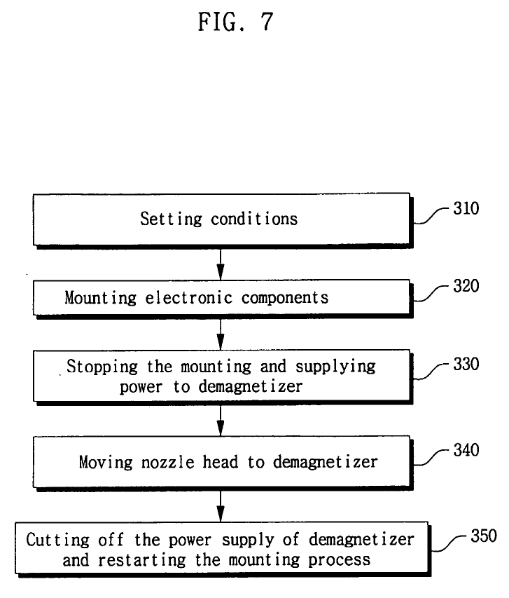

FIG. 7 is a flow chart of a demagnetizing method in accordance with an example embodiment of the present invention.

An example embodiment of a demagnetizing method in accordance with the present invention may comprise setting conditions 310 including, for example, a demagnetizing cycle, nozzle operating conditions, demagnetizing conditions, etc. The electronic component mounting apparatuses 100 and 200 of the above example embodiments of the present invention may have a controller (not shown) for controlling the example embodiments of the present invention. An operator may recognize the progress state of a process through a display (not shown). Further, the operator may set and/or alter control conditions of the controller through the display and/or an input unit (not shown). In a method according to an example embodiment of the present invention, conditions including a demagnetizing cycle, nozzle operating conditions and demagnetizing conditions may be set in the manner previously described.

According to an example embodiment of the present invention, the demagnetizing cycle may be a period when a demagnetizing process is performed on the head nozzles 122 and 222 using the demagnetizers 160 and 260, for example. The demagnetizing cycle may include a time period, a date period, and a period related to the frequency of the component mounting. An operator may select a proper cycle value among a time period, a date period, and the number of times of the component mounting from a display, and/or may directly input a cycle value through an input unit (not shown).

According to an example embodiment of the present invention, the nozzle operating conditions may be conditions under which the head nozzles 122 and 222 move above and/or in the demagnetizers 160 and 260, for example. The nozzle operating conditions may include location, height and speed of nozzle movement. An operator may select a proper nozzle operating condition value on from a display, and/or may input the nozzle operating condition value through an input unit.

According to an example embodiment of the present invention, the demagnetizing conditions may be conditions of a demagnetizing process and may include a demagnetizing time, frequency of nozzle movement, etc. For example, in the case of the head nozzle 122 moving above the demagnetizer 160, the demagnetizing conditions may be the frequency of nozzle movement. In the case of the head nozzle 222 moving in the U-shaped frame of demagnetizer 260, the demagnetizing conditions may be the demagnetizing time. The operator may set proper demagnetizing conditions through a display and/or an input unit.

According to an example embodiment of a method of the present invention, an electronic component mounting process may be performed 320. During the component mounting process, the head nozzles 122 and 222 may absorb the electronic components 10 and may mount the electronic components 10. The mounting process may be repetitive.

According to an example embodiment of a method of the present invention, when a demagnetizing cycle is due to be performed, the mounting process may be stopped and power may be supplied to the demagnetizers 330. For example, a controller may stop the mounting process based on a setting value and may close the switches 164 and 264 to supply an alternating current to the demagnetizers 160 and 260, for example, which may result in an alternating magnetic field created by the demagnetizers 160 and 260.

According to an example embodiment of a method of the present invention, the head nozzles 122 and 222 may be moved to the demagnetizers 160 and 260, for example, according to the set nozzle operating conditions to demagnetize the head nozzles 122 and 222 according to demagnetizing conditions 340. For example, the controller may operate the head tables 110 and 210 to move the head nozzles 122 and 222 according to the setting value of the nozzle operation conditions and may perform a demagnetizing process according to the setting value of the demagnetizing conditions.

According to an example embodiment of the present invention as described with respect to an electronic component 100, the head table 110 may be rotated to move the head nozzle 122 above the demagnetizer 160. According to an example embodiment of the present invention as described with respect to the electronic component apparatus 200, the head table 210 may be operated to move the head nozzle 222 in the demagnetizer 260.

According to an example embodiment of a method of the present invention, a controller may cut off the power supply of the demagnetizers 160 and 260 and restart the mounting process 350.

The demagnetizing cycle, nozzle operating conditions and demagnetizing conditions may be varied according to the standard of the head nozzle, characteristics and size of the electronic components, characteristics and capacity of the demagnetizer, characteristics and size of the head table, etc. A suitable value may be deduced from experiments and/or analysis of process records.

In accordance with the example embodiments of the present invention, the electronic component mounting apparatus may have a demagnetizer for automatically demagnetizing a head nozzle. Accordingly, faults which may result from magnetism of the head nozzle may be reduced and/or productivity may be improved.

Further, example embodiments of the present invention may address faults related to a magnetized head nozzle without changing the material of a head nozzle.

Although example, non-limiting embodiments of the present invention have been described in detail hereinabove, it should be understood that many variations and/or modifications of the basic inventive concepts herein taught, which may appear to those skilled in the art, still fall within the spirit and scope of the example embodiments of the present invention.

What is claimed is:

1. An electronic component mounting apparatus comprising:
a head table;
at least one mount head arranged on the head table;
a head nozzle provided at a lower end of the at least one mount head;
a component feeder configured to provide electronic components;
a component sensor configured to sense the electronic components;
a component mounter configured to mount the electronic components on a printed circuit board; and
a demagnetizer configured to create an alternating magnetic field to demagnetize the head nozzle.

2. The apparatus of claim 1, wherein the head table is a rotating cylinder, and the at least one mount head is arranged on a periphery of the head table.

3. The apparatus of claim 1, wherein the head table is a movable plate, and the at least one mount head is provided along one side of the head table.

4. The apparatus of claim 2, wherein the head table has a cam follower configured to move the at least one mount head.

5. The apparatus of claim 3, wherein the at least one mount head includes a plurality of mount heads and the head table includes a plurality of hydraulic cylinders configured to move the plurality of mount heads.

6. The apparatus of claim 1, wherein the component mounter includes an X-Y table configured to move the printed circuit board.

7. The apparatus of claim 2, wherein the demagnetizer is provided in a rotating route of the at least one mount head.

8. The apparatus of claim 3, wherein the demagnetizer is provided in a moving route of the at least one mount head.

9. The apparatus of claim 1, wherein the demagnetizer includes a frame and an iron core including coils embedded in the frame.

10. The apparatus of claim 9, wherein the frame is U-shaped.

11. The apparatus of claim 1, wherein the demagnetizer is connected to an alternating current source through a switch.

12. A method for demagnetizing an electronic component mounting apparatus, the method comprising:
setting conditions including at least one of a demagnetizing cycle, nozzle operating conditions and demagnetizing conditions;
mounting electronic components; and
demagnetizing a head nozzle of the electronic component mounting apparatus based on the conditions.

13. The method of claim 12, wherein the demagnetizing includes
stopping the mounting and supplying power to a demagnetizer;
moving a head nozzle to the demagnetizer to demagnetize the head nozzle; and
cutting off a power supply of the demagnetizer and restarting the mounting.

14. The method of claim 12, wherein the demagnetizing cycle includes at least one of a time period, a date period, and a frequency of the component mounting.

15. The method of claim 12, wherein the nozzle operating conditions include at least one of location of a head nozzle, height of a head nozzle and speed of head nozzle movement.

16. The method of claim 12, wherein the demagnetizing conditions include at least one of a demagnetizing time and a frequency of demagnetizing the head nozzle.

17. The method of claim 12, wherein the setting of conditions includes selecting setting values on a display of the electronic component mounting apparatus.

18. The method of claim 12, wherein the setting of conditions includes inputting setting values through an input unit of the electronic component mounting apparatus.

19. The method of claim 13, wherein the moving of the head nozzle includes rotating the head table to move the head nozzle above the demagnetizer.

20. The method of claim 13, wherein the moving of the head nozzle includes operating the head table to move the head nozzle in the demagnetizer.

21. An electronic component mounting apparatus comprising:
a head nozzle configured to transfer electronic components to a component mounter; and
a demagnetizer configured to create an alternating magnetic field to demagnetize the head nozzle.
